(19) United States
(12) Patent Application Publication
(10) Pub. No.: US 2009/0253816 A1
(43) Pub. Date: Oct. 8, 2009

(54) COMPOSITION FOR PREPARING A BIODEGRADABLE POLYURETHANE- BASED FOAM AND A BIODEGRADABLE POLYURETHANE FOAM

(75) Inventors: Jefter Fernandes Nascimento, Sao Paulo City (BR); Wagner Mauricio Pachekoski, Sao Carlos (BR); Jose Ricardo De Lello Vicino, Sao Carlos (BR)

Correspondence Address: DARBY & DARBY P.C., P.O. BOX 770, Church Street Station, New York, NY, 10008-0770, US

(73) Assignees: PHB INDUSTRIAL S.A., Serrana - SP (BR); KEHL INDUSTRIA E COMERCIO LTDA, San Carlos - SP (BR)

(21) Appl. No.: 12/280,388

(22) PCT Filed: Feb. 23, 2007
(86) PCT No.: PCT/BR07/00049

§ 371 Date: Oct. 10, 2008

(30) Foreign Application Priority Data
Feb. 24, 2006 (BR) PI0600784-8

(51) Int. Cl. C08L 75/04

(52) U.S. Cl. 521/90; 521/159; 521/82; 521/92; 521/95; 521/98

(57) ABSTRACT

Composition for preparing a biodegradable polyurethane-based foam and a biodegradable polyurethane foam, comprising mixtures based on poly(hydroxybutyrate) polymer, polyols of renewable source, isocyanates and additives, with the object of preparing biodegradable polyurethane foams. In the process, the poly(hydroxybutyrate) plus the polyol, the isocyanate and the additives are previously mixed in specific mixers; once the homogenization is reached, the mixture is poured in mold for growing. After curing, the resulting product presents foam characteristics, with its density, toughness and cell size varying according to the proportion of the reagents and allowing the manufacture of several products.

### FIELD OF THE INVENTION

The present invention refers to a biodegradable polymeric composition based on polyhydroxybutyrate or copolymers thereof and comprising a polyol of renewable source, an isocyanate and several optional additives, resulting in a product with its density, toughness and size of cells ranging according to the proportion of the reagents and allowing the manufacture of various products obtained by injection and presenting good finishing.

### PRIOR ART

There are known from the prior art different composite materials in the form of biodegradable polyurethane foams, comprising a biodegradable filling material that is mixed with a polyol and an isocyanate to form the polyurethane foam. It is also known the addition of different additives to said mixture in order to improve its production and/or its properties.

Document JP11236429A2 describes a biodegradable polyurethane composite used as molding material consisting of predetermined quantities of vegetable material in powder and/or short fibers, molasse and/or lignin and polyhydric alcohol and polyisocyanates, resulting in a polyurethane of excellent biodegradability and mechanical strength, besides having an economically viable production method.

In this prior art solution, the biodegradable filling material is defined by unprocessed vegetable material, considerably limiting the application of the composite material in the formation of injected articles.

A similar solution is described in document JP10324729A2, which proposes the formation of biodegradable polyurethanes utilizing molasses mixed with a polyol and with a polyisocyanate. Also in this case, the filling material is a material of vegetable origin, which fact also limits the applications of the polymeric material in the formation of articles that require more aprimorated finishings.

There are also known from the prior art other biodegradable polyurethane foams obtained from different biodegradable materials of vegetable origin and which can include monosaccharides, polysaccharides and other filling ingredients.

Although leading to biodegradable polyurethanes materials, these known solutions utilize filling materials that do not allow applying the raw material in the injection of articles that require high quality finishing. The known solutions allow molding different articles with a rather coarse finishing, as the biodegradable filling material remains physically not diluted in the polyurethanic matrix.

### SUMMARY OF THE INVENTION

As a function of the aspects described above, it is a generic object of the present invention to provide a biodegradable polyurethane-based foam, comprising polymers and copolymers thereof, obtained from polyhydroxyalkanoates and which presents improved physical and chemical properties to increase its application field and to allow its production by simple and fast processes/methods and which is also economically viable for large scale production.

According to the invention, the composition for preparing a biodegradable polyurethane-based foam comprises poly(hydroxybutyrate) or copolymers thereof; a polyol of renewable source; an isocyanate and at least one additive presenting one of the functions: catalyst, surfactant, pigmentation, filler and expansion.

The composition defined above is adequate to the production of polyurethane foams for obtaining several articles, by means of a simple, fast and inexpensive processing of said composition, with being aggressive to the environment.

### DETAILED DESCRIPTION OF THE INVENTION

### Materials

Poly(3-hydroxybutyric acid)—PHB

Within the class of the biodegradable polymers, the structures containing ester functional groups are of great interest, mainly due to their usual biodegradability and versatility in physical, chemical and biological properties. Produced by a large variety of microorganisms, as a source of energy and carbon, the polyalkanoates (polyesters derived from carboxylic acids) can be synthesized either by biological fermentation or chemically.

The poly(hydroxybutyrate)—PHB is the main member of the class of the polyalkanoates. Its great importance is justified by the combination of 3 important factors: it is 100% biodegradable, water-resistant and it is a thermoplastic polymer, enabling the same applications as the conventional thermoplastic polymers. Formula 1 presents the structure of the (a) 3-hydroxybutyric acid and of the (b) Poly(3-hydroxybutyric acid)—PHB.

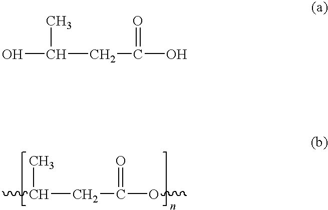

PHB was discovered by Lemognie in 1925 as a source of energy and carbon storage in microorganisms, as in the bacteria Alcaligenis euterophus, in which, under optimal conditions, above 80% of the dry weight is PHB. Nowadays, the bacterial fermentation is the main production source of the poly(hydroxybutyrate), in which the bacteria are fed in reactors with butyric acid or fructose and left to grow, and after some time the bacterial cells are extracted from the PHB with an adequate solvent.

The production process of the poly(hydroxybutyrate) is basically constituted of two steps:
fermentative step: in which the microorganisms metabolize the sugar available in the medium and accumulate the PHB in the interior of the cell as source of reserve;
extraction step: in which the polymer accumulated in the interior of the cell of the microorganism is extracted and purified until a solid and dry end product is obtained.

Developments about the subject matter allowed utilizing sugar and/or molasse as basic constituents of the fermentative medium, the fusel oil (organic solvent—byproduct of the alcohol manufacture) as an extraction system of the polymer synthesized by the microorganisms, as well as permitted the use of the excess of sugarcane bagasse to produce energy (vapor generation) for these processes. This project allowed a perfect vertical integration with the maximum utilization of byproducts generated in the sugar and alcohol manufacture, generating processes that utilize the so-called clean and ecologically correct technologies.

Through a production process similar to that of the PHB, it is possible to produce a semicrystalline bacterial copolymer of poly-(3-hydroxybutyrate) with random segments of poly(3-hydroxyvalerate), known as PHBV. The main difference between the two processes is based on the increase of proprionic acid in the fermentative medium. The quantity of proprionic acid in the bacteria feeding is responsible for controlling the hydroxyvalerate concentration—HV in the copolymer, enabling the variation of degradation time (which can be from some weeks to several years) and certain physical properties (molar mass, degree of crystallinity, surface area, for example).

The composition of the copolymer further influences the melting point (which can range from 120 to 180° C.), and the characteristics of ductility and flexibility (which are improved with the increase of PHV concentration) Formula 2 presents the basic structure of the PHBV.

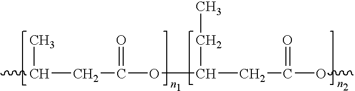

According to some studies, the PHB shows a ductile behavior with a maximum elongation of 40%, tension elastic modulus of 1.4 GPa and notched IZOD impact strength of 90 J/m soon after the injection of the specimens. Such properties modify with time and stabilize in about one month, with the elongation reducing from 40% to 10% after 15 days of storage, reflecting the fragilization of the material. The tension elastic modulus increases from 1.4 GPa to 3.5 GPa, while the impact strength reduces from 90 J/m to 25 J/m after the same period of storage. Table 1 presents some properties of the PHB compared to the Isostatic Polypropylene (commercial Polypropylene). This phenomenon, known as “aging”, is attributed to secondary crystallizations and confinement of the amorphous regions, will be discussed ahead. Table 1 presents some properties of the PHB compared to the Isostatic Polypropylene.

TABLE 1
Comparison of the PHB and the PP properties.

| Properties | PHB | PP |
|---|---|---|
| % of crystallinity | 80 | 70 |
| Average molar mass (g/mol) | 4 × 105 | 2 × 105 |
| Melting Temperature (° C.) | 175 | 176 |
| Glass transition temperature (° C.) | −5 | −10 |
| Density (g/cm³) | 1.2 | 0.905 |
| Modulus of Flexibility (Gpa) | 1.4-3.5 | 1.7 |
| Tensile strength (MPa) | 15-40 | 38 |
| Elongation at break | 4-10 | 400 |
| UV Resistance | good | poor |
| Solvent Resistance | Poor | good |

The degradation rates of the articles made of PHB or its Poly(3-hydroxybutyric-co-hydroxyvaleric acid)—PHBV copolymers, under several environmental conditions, are of great relevance for the user of these articles. The reason that makes them acceptable as potential biodegradable substitutes for the synthetic polymers is their complete biodegradability in aerobic and anaerobic environments to produce CO₂/H₂O/biomass and CO₂/H₂O/CH₄/biomass, respectively, through natural biological mineralization. This biodegradation usually occurs via surface attack by bacteria, fungi and algae. The actual degradation time of the biodegradable polymers and, therefore, of the PHB and PHBV, will depend upon the surrounding environment, as well as upon the thickness of the articles.

### Polyols of Natural Origin

The natural polyols considered in the present invention are renewable materials of biological origin to be used for obtaining degradable polyurethanes products of commercial interest. They are structures, whose chain presents hydroxyl groups, which can react with isocyanate groups, resulting in urethane bonds.

The polyols notably comprise reactive derivative and mixtures of the following products: xylose, arabinose, glucose, sacharose, dextrose syrups, glycose syrup, maltose syrup, maltodextrines, dextrines, amylogens, glycerin, cornstarch, rice starch, potato starch and manioc starch, humic acids, triethanolamine, rice husk, castor cake, carbonized rice husk, vegetable oils, such as castor, corn and soybean oils.

An important raw material for obtaining polyols is the castor-oil, a mixture that contains about 90% of triglyceride of the ricinoleic acid. Besides being found practically pure in nature, it is also a rare source of hydroxylated and unsaturated fatty acid. Its idealized composition and structure are showed respectively in Table 2 and Table 3. Due to its composition and privileged structure, it can suffer several chemical reactions, which can result in a great variety of products.

The polyol of renewable source is present in the composition in a mass proportion lying from about 10% to about 50%, preferably from about 15% to about 40%. The Polyols used for obtaining the foams object of the present invention are defined in more details in Brazilian patent documents PI-9700618-1, PI-02005623-2, PI-04044668-4 and PI-0301270-0.

TABLE 2
Castor-oil composition

| Component | Quantity |
|---|---|
| Ricinoleic Acid | 89.5% |
| Dihydroxystearic Acid | 0.7% |
| Palmitic Acid | 1% |
| Stearic Acid | 1% |
| Oleic Acid | 3% |
| Linoleic Acid | 4.2% |

Table 3 shows the standard properties of the castor oil.

TABLE 3
Standard Properties of the castor oil.

| Property | Value |
|---|---|
| Acidity Index (mg/KOH/g) - max | 2.0 |
| Gardner Color- max | 2.0 |
| Hydroxyl Index (mg/KOH/g) | 160-170 |
| Heat loss (% max.) | 0.2 |
| Index of Refraction, 25° C. | 1.4764-1.4778 |
| Saponification Index | 176-178 |
| Iodine Index | 84-88 |
| Solubility in alcohol (ethanol) | Complete |
| Density, 25° C. | 0.957-0.961 |
| Viscosity cm2/s (Stokes) | 6.5-8 |
| Ignition Temperature, ° C. | 449 |
| Surface Stress (dyn/cm), 20° C. | 39 |

### Triglyceride

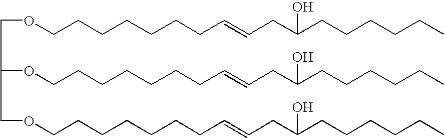

### Idealized Structure of the Castor Oil.

### Isocyanates

The isocyanates are used in the reaction with the Polyols and additives, forming the biodegradable polyurethane foams, as described. The result obtained is process of expansion resulting from the reaction of the Polyols with polyisocyanates, and comprises at least 2 isocyanate functional groups. The generic reaction of this process is described in Formula 4, whereas the generic bond for this process is described in Formula 5.

The polyisocyanates, which can be used for obtaining of the foams described, comprise aromatic, aliphatic, cycloaliphatic compounds, combinations thereof, as well as those obtained from the trimerization with water. 1-methyl-benzene 2,4-diisocyanate, 1-methylbenzene 2,6-diisocyanate, 1,1-methylene bis(4-isocyanate benzene), 1-isocyanate-2(4-isocyanate phenyl)benzene, naphthalene 1,5-diisocyanate, 1,1′,1″-methylenetris (benzene 4-isocyanate), p-phenylenediisocyanate and mixtures thereof can be used.

The aliphatic polyisocyanates comprise the 1,6-diisocyanate, and the cycloaliphatic polyisocyanates comprise the cyclohexane-5-isocyanate-1-(methylisocyanate)-1,3,3′-trimethyl.

The isocyanates are incorporated in the composition of the present solution in a mass proportion lying from about 20% to about 60%, preferably from about 35% to about 55%.

Due to the production facility and reduced costs, the more useful diisocyanates for obtaining the foams described in the present solution are the 2,4-diisocyanate of 1-methyl-benzene and the toluene diisocyanate, whose idealized structures are showed in Formula 6.

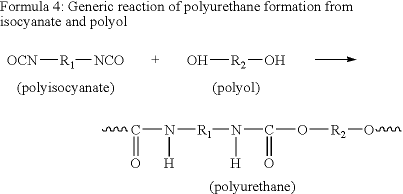

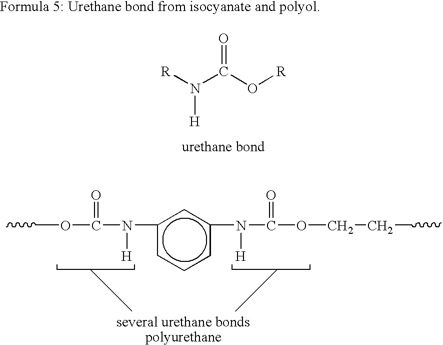

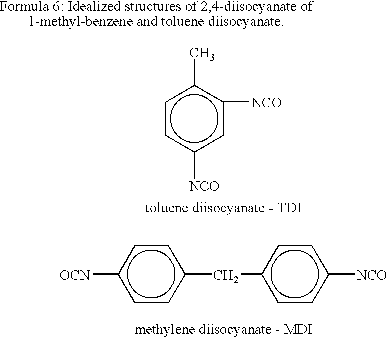

### Additives

Additives are compounds added in small quantities that promote alterations and improvements in the obtained foams. Catalysts, surfactants, pigments, fillers, expanding agents, flame retardants, antioxidants, radiation protectors, are preferably used, individually or in mixtures.

The added catalyst based on terciary amines comprise triethylenediamine, penthamethyldiethylenetriamine, N-ethylmorfiline, N-methylmorfiline, tetramethylethylenediamine, dimethylbenzylamine, 1-methyl-4-dimethylamine ethylpiperazine, N,N-diethyl 3-diethylamine propylamine, 1-(2-hydroxypropyl)imidazol; other types of useful catalysts can be of the organotin, organoferric, organomercury and organolead types, as well as inorganic salts of alkaline metals present in the composition in a mass proportion lying from about 0.5% to about 3%, preferably from about 1% to about 2%.

The surfactants comprise organic surfactants, preferably fatty acids and organo-silane used individually or in mixtures. Preferably, the fatty acids comprise salts of the sulphonated ricinoleic acid, organo, whereas silanes comprise poly(dimethylsiloxane) and poly(phenylmethylsiloxane), individually or in mixtures, being present in the composition in a mass proportion lying from about 0.5% to about 3%, preferably from about 1% to about 2%.

The pigments comprise metallic oxides and carbon black, individually or in mixtures, such as azo compounds, phthalocyanines and dioxazines, present in the composition in a mass proportion lying from about 0.5% to about 3%, preferably from about 1% to about 2%.

The fillers comprise particles and fibers, individually or in mixtures, mainly carbonates, alumine and silica, individually or in mixtures, as well as natural and synthetic fibers, present in the composition in a mass proportion lying from about 0.5% to about 3%, preferably from about 1% to about 2%.

Several expanding agents can be used for obtaining the described foams. Apart from the chlorofluorocarbons, used for a long time as expanding agents, including difluorochloromethane, difluoroethane, tetrafluoroethane, described in U.S. Pat. No. 4,945,119, environmental pressures forced the production of new expanding agents less aggressive to the ozone layer, such as for example, the aliphatic and cycloaliphatic components: n-penthane, i-penthane, cyclopenthane or mixtures thereof, as described in Brazilian patent PI 9509500-4.

Nevertheless, in the present solution the expanding agent can be defined only by water, which reacts with the polyisocyanate, forming carbon dioxide.

The additive of the expanding agent type used in the present invention can be selected from difluorochloromethane, difluoroethane, tetrafluoroethane, n-penthane, i-penthane, cyclopenthane or mixtures thereof, or water, and can be incorporated in the composition in a mass proportion lying from about 0.5% to about 3%, preferably from about 1% to about 2%.

### 3—Methodology for Producing the Biodegradable Polyurethane Foams

For obtaining the foams object of the present invention, the polyol, the polyisocyanate and all the components and additives are mixed with efficiency in specific equipments established in the market, commonly denominated “foam injectors”. They are equipments that accurately and efficiently dose and mix the polyol and isocyanate precursory reagents.

In the equipments commonly used in the market for obtaining the traditional foams, the mixture of the raw materials, polyols and isocyanates can be made through high and low pressure modalities, with or without control of temperature, material flow, and other important parameters in the processing of the foams.

The foams were also obtained through a mixer especially developed for this purpose, in which the components are individually added and subsequently mixed, then resulting in the foams.

### 4—Description of the Formulations and Properties of the Compounds

According to the reagent proportions in the composition of the foams, products of variable density and toughness were obtained, where products with higher concentration of poly(hydroxybutyrate) presented higher density and products with higher concentration of polyol presented lower density. These foams can be used in any situation which requires a tough, semi-tough or flexible foam. The actuation field of the described foams is the same as the expanded polyestyrene, except in the construction field.

Due to their intrinsic properties of degradation, the applications in which this characteristic is desirable are those of great importance, mainly in “one way” products, such as packages and specific agricultural areas. The most adequate applications would be package dunnages, packages for electro-electronic products, disposable food packages, agricultural trays for growing plant seedlings and hydropony, and plant seedling recipients for reforestation.

The high toughness obtained in certain types of foam (examples 4 and 5) makes these products unique for certain types of applications, such as in the use of seedling trays. For this application, the material needs toughness and hardness properties which can support, besides the tray structure, the weight of both the substrate and the plant seedlings. The increment of the toughness and hardness properties is easily obtained by using PHB in the formulation. Such properties are not easily found in the traditional foams, making unfeasible in practice their application in this market niche.

The properties obtained by using PHB in the formulation of the foams object of the present invention allow them to be thermoformed, eliminating the expansion step in molds for obtaining the products. The examples are cited below and in Table 4.

### Example 1

Tests of mixtures with 4.85% of poly(hydroxybutyrate), 43.69% of polyol, 48.56% of isocyanates and 1.45% of surfactant.

### Example 2

Tests of mixtures with 9.7% of poly(hydroxybutyrate), 38.84% of polyol, 48.56% of isocyanates and 1.45% of surfactant.

### Example 3

Tests of mixtures with 14.56% of poly(hydroxybutyrate), 33.98% of polyol, 48.56% of isocyanates and 1.45% of surfactant.

### Example 4

Tests of mixtures with 19.42% of poly(hydroxybutyrate), 29.12% of polyol, 48.56% of isocyanates and 1.45% of surfactant.

### Example 5

Tests of mixtures with 24.27% of poly(hydroxybutyrate), 24.27% of polyol, 48.56% of isocyanates and 1.45% of surfactant.

TABLE 4
Concentrations and properties of the
biodegradable polyurethane foams.

| | % | % | % | % | % | Density |
|---|---|---|---|---|---|---|
| PRODUCTS | PHB | Polyol | Isocyanate | Catalyst | Surfactant | (g/cm3) |
| Ex. 1 | 4.85 | 43.69 | 48.56 | 1.45 | 1.45 | 15-20 |
| Ex. 2 | 9.7 | 38.84 | 48.56 | 1.45 | 1.45 | 20-30 |
| Ex. 3 | 14.56 | 33.98 | 48.56 | 1.45 | 1.45 | 30-40 |
| Ex. 4 | 19.42 | 29.12 | 48.56 | 1.45 | 1.45 | 40-50 |
| Ex. 5 | 24.27 | 24.27 | 48.56 | 1.45 | 1.45 | 50-60 |

### 5—Essays of Biodegradation

Pulverized samples of the foams cited in the invention had their biodegradability evaluated in biologically active soil over a period of 120 days. It was detected that, in this period of time, these samples were totally consumed, characterizing the biodegradability of the material.

1. Composition for preparing a biodegradable polyurethane-based foam, characterized in that it comprises poly(hydroxybutyrate) or copolymers thereof; a polyol of renewable source; an isocyanate and at least one additive presenting one of the functions: catalyst, surfactant, pigmentation, filler and expansion.

2. Composition, as set forth in claim 1, characterized in that the biodegradable polymer, defined by poly(hydroxybutyrate) or its poly(hydroxybutyrate-valerate) copolymer, is provided in the composition in a mass proportion lying from about 2% to about 50%, preferably from about 4% to about 30%.

3. Composition, as set forth in claim 2, characterized in that the polyol of renewable source is derived from the following products or mixtures thereof: xylose, arabinose, glucose, sacharose, dextrose syrups, glycose syrup, maltose syrup, maltodextrines, dextrines, amylogens, glycerin, cornstarch, rice starch, potato starch and manioc starch, humic acids, triethanolamine, rice husk, castor cake, carbonized rice husk, vegetable oils, such as, castor, corn and soybean oils, present in the composition in a mass proportion lying from about 10% to about 50%, preferably from about 15% to about 40%.

4. Composition, as set forth in claim 3, characterized in that the isocyanate is 1-methyl-benzene 2,4-diisocyanate, 1-methylbenzene 2,6-diisocyanate, 1,1-methylene bis(4-isocyanate benzene), 1-isocyanate-2(4-isocyanate phenyl)benzene, naphthalene 1,5 diisocyanate, 1,1′,1″-methylenetris(benzene 4 isocyanate), p-phenylenediisocyanate, 1,6-diisocyanate, 1,3,3′-trimethyl cyclohexane-5-isocyanate-1-(methylisocyanate), toluene diisocyanate and mixtures thereof, present in the composition in a mass proportion lying from about 20% to about 60%, preferably from about 35% to about 55%.

5. Composition, as set forth in claim 4, characterized in that the additive of the catalyst type is selected from: triethylenediamine, pentamethyldiethylenetriamine, N-ethylmorphiline, N-methylmorphiline, tetramethylethylenediamine, dimethylbenzylamine, 1-methyl-4-dimethylamine ethyl piperazine, N,N-diethyl 3-diethylamine propylamine, 1-(2-hydroxypropyl)imidazole or other organotin, organoferric, organomercury and organolead catalysts, as well as inorganic salts of alkaline metals, present in the composition in a mass proportion lying from about 0.5% to about 3%, preferably from about 1% to about 2%.

6. Composition, as set forth in claim 4, characterized in that the additive of the surfactant type is selected from a salt of the sulphonated ricinoleic acid, a poly(dimethylsiloxane) and a poly(phenylmethylsiloxane), individually or in mixtures, present in the composition in a mass proportion lying from about 0.5% to about 3%, preferably from about 1% to about 2%.

7. Composition, as set forth in claim 4, characterized in that the additive of the pigment type is selected from: metallic oxide, carbon black, azo compounds, phthalocyanines and dioxazines, individually or in mixtures, present in the composition in a mass proportion lying from about 0.5% to about 3%, preferably from about 1% to about 2%.

8. Composition, as set forth in claim 4, characterized in that the additive of the filler type is selected from carbonates, alumine and silica, individually or in mixtures, as well as from natural and synthetic fibers, present in the composition in a mass proportion lying from about 0.5% to about 3%, preferably from about 1% to about 2%.

9. Composition, as set forth in claim 4, characterized in that the additive of the expanding agent type is selected from: difluorochloromethane, difluoretane, tetrafluoretane, n-penthane, i-penthane, cyclopenthane or mixtures thereof, present in the composition in a mass proportion lying from about 0.5% to about 3%, preferably from about 1% to about 2%.

10. Composition, as set forth in claim 4, characterized in that the additive of the expanding agent type is water, being present in the composition in a mass proportion lying from about 0.5% to about 3%, preferably from about 1% to about 2%.

11. Biodegradable polyurethane foam to be used, for example, in package dunnages for electro-electronic products, disposable food packages, agricultural trays for growing plant seedlings and hydropony and in plant seedling recipient for reforestation, characterized in that it comprises the product from the reaction of: from about 2% to about 50% in mass of polyhydroxybutyrate or its poly-hydroxybutyrate-valerate copolymer; from about 10% to about 500% of a polyol of renewable source; from about 20% to about 60% of isocyanate; from about 0.05% to about 3% of at least one additive presenting one of the functions: catalyst, surfactant, pigmentation, filler and expansion.

12. Biodegradable polyurethane foam, as set forth in claim 11, characterized in that it comprises from about 4% to about 30% in mass of polyhydroxybutyrate or its poly-hydroxybutyrate-valerate copolymer; from about 15% to about 40% of a polyol of renewable source; from about 35% to about 55% of isocyanate; from about 1% to about 2% of at least one additive presenting one of the functions: catalyst, surfactant, pigmentation, filler and expansion.
